(19) United States
(12) Patent Application Publication
(10) Pub. No.: US 2012/0078779 A1
(43) Pub. Date: Mar. 29, 2012

(54) Real Estate Financing System and Method

(76) Inventor: Larry Robertson, Bella Vista, AR (US)

(21) Appl. No.: 13/247,669

(22) Filed: Sep. 28, 2011

Related U.S. Application Data
(60) Provisional application No. 61/404,120, filed on Sep. 28, 2010.

(51) Int. Cl. G06Q 40/02

(52) U.S. Cl. 705/38

(57) ABSTRACT

A method for facilitating and reducing the risk for both the homebuyer and the investor providing the funds for the purchase of a home includes requiring that the homebuyer execute a non-recourse finance agreement agreement at the time of the purchase of the home. The purchase of the purchase will also include a non-recourse forfeiture agreement by which the homeowner or the investor providing the funds for the purchase of the home may enable the purchase of the home from the homeowner by the investor providing the funds for the purchase of the home.

### CROSS REFERENCE TO RELATED APPLICATION

This application claims the benefit of U.S. Provisional Application No. 61/404,120, filed Sep. 28, 2010.

### STATEMENT REGARDING FEDERALLY FUNDED RESEARCH AND DEVELOPMENT

The invention described in this patent application was not the subject of federally sponsored research or development.

### FIELD

The present invention pertains to a system and method for buyers to be transformed from being unable to obtain the needed funding for a real estate related purchase into being able to obtain the needed funding for a real estate related purchase. More particularly, the system and method of the present invention pertains to the financing of a real estate related purchase using the resources of a business organized and operating like a Real Estate Investment Trust (REIT) together with a series of steps created to simplify the real estate buying process while, at the same time, reducing the risk for both the real estate purchaser and the investors who own a business organization that loans money needed by the real estate purchaser to complete a purchase.

### BACKGROUND

The collapse of the sub-prime mortgage industry in the United States triggered a global financial crisis that extended far beyond the real estate and banking sectors of the economy. One of the most negative effects of this crisis was the reaction of many homeowners. Specifically many homeowners threw up their hands and simply walked away from their homes in large numbers.

The sequence of events which led to the sub-prime mortgage industry crisis is considered by some to include the following:

a large number of loans for the purchase of a home were originated with adjustable interest rates which provided an affordable fixed rate payment for an initial period of 1-5 years;

after the initial 1-5 year period, the interest rate and resulting periodic payments due the lender increased to a point that was no longer affordable for some borrowers;

many home purchasers either left their homes or stopped making payments on their home loan;

a large number of either abandoned homes or homes where loan payments were no longer being made went into foreclosure;

lenders incurred substantial losses from the legal expenses associated with the foreclosure of homes, the repair costs needed to restore the foreclosed homes to a sellable condition, and the wide-spread decline in home prices caused by increased competition from a rapidly increasing number of low-priced foreclosed homes entering the open market;

excessive inventory of homes available for sale and reduced prices on homes available for sale created market pressures which caused home prices to erode. This home price erosion made nearly all home loans (not just sub-prime home loans) that had been originated in recent years and where there was a minimal down payment, difficult to refinance due to the effect of lower home prices. This rapid drop in home prices caused many homeowners to be in a situation where they owed more on their home purchase loan than what the home could be sold for on the open market; and

the cycle of foreclosures and decreasing home prices continued to exacerbate until it reached the point where the global economy was affected.

A close look at the conditions triggering the collapse of the sub-prime mortgage industry and the far reaching effects of the ensuing devastating drop in the prices of homes have revealed that, contrary to what many people believe, the collapse of the sub-prime mortgage industry had little to do with lax credit standards or falling home values caused by exogenous forces.

Rather, the real and ongoing problem, which was a significant factor in the collapse of the sub-prime mortgage industry, was and remains the current set of procedures used for selling and financing the purchase of a residence. Specifically, the current set of procedures used for selling and financing the purchase of a residence is decentralized and distant from the residences being managed.

The inefficiencies associated with the current set of procedures for managing the purchase and sale of residences have caused home owners and investors alike to lose billions of dollars of equity. Such inefficiencies in the current set of procedures stem from the fact that every real estate transaction involving a home purchase loan requires some level of involvement of more than a dozen third-party service providers and regulatory agencies. Oftentimes, these third party service providers and regulatory agencies possess less than a thorough knowledge of the regulatory demands and transactional intricacies of the other participants. Further, these third party service providers and regulatory agencies may be in locations far apart from one another. As a result, the average real estate transaction involving a home purchase loan has become more and more complicated and, in some cases, may take 4-8 weeks to finalize.

Another drawback to the current set of procedures for purchasing and selling a residence is that the downside risk for investors within the existing home loan purchase financing system has become so great that millions of Americans with the determination and ability to meet loan repayment obligations have been transformed into potential real estate purchasers unable to get a home loan from lenders and real estate sellers who are hampered by the set of procedures used in the current system while still recovering from the effects of the recent sub-prime mortgage industry collapse.

The existing real estate purchase financing system continues to pose numerous challenges for the homeowner. Such challenges include:

a. The transaction fees incurred when selling a home consume many years' worth of accumulated homeowner equity. Oftentimes, the owner of a home will end up with little or nothing to show for investing in the purchase of a home other than a personal tax write-off and possibly an enhanced credit history.

b. The fees and commissions associated with selling a home often hold the owners of homes as prisoners in their own homes until they are able to accrue enough equity to cover the necessary fees and commissions or at least break even.

c. Moving up to another home worth 25% more than an occupied home may require building up as much as 10 years worth of equity in the occupied home to cover the fees and commissions as well as a conventional down payment of 20% of the purchase price of another home.

The consequences of the foregoing challenges are that the process of buying and selling real estate, particularly a home, has complicated what should be a relatively simple process. Not only have the consequences of buying and selling a home affected home buyers and home sellers, but builders, investors and banks have also suffered. Specifically, builders, investors, banks, federal agencies such as the FHA, Fannie Mae and Freddie Mac have large inventories of homes they cannot sell. At the same time, many potential home buyers are being denied credit for irrelevant technicalities or unfortunate single-events that are unlikely to recur.

There is, therefore, a need for a system to transform potential buyers of real estate who have been denied credit for minor problems together with those who are seeking buyers for real estate which they have been unable to sell. There is also a need to transform the current complicated system of buying and selling real estate, particularly a home, into a more simplified system which will make the buying and selling of real estate easier for all those involved.

### SUMMARY

The disclosed system and method is described primarily with regard to home sales. Those of ordinary skill in the art will understand the applicability of the disclosed system and method to a wide variety of real estate transactions.

The present invention provides both a system and method for facilitating transactions between potential homeowners and those who have homes to sell and a centralized and simplified system and method for the buying and selling of homes that will protect the home builders, the investors in the real estate industry, and the banks who execute the financing transactions associated with the buying and selling of a home. More particularly, the present invention transforms a situation where a real estate related transaction cannot take place into a situation where a real estate related transaction can take place thereby providing a new opportunity for a real estate transaction where heretofore none existed.

The method which enables the system of the disclosed invention to transform a real estate transaction which is unable to take place into a real estate transaction which can take place and create this new opportunity includes the following steps.

First, monies are accumulated in a business that is organized and operates like a traditional Real Estate Investment Trust (REIT). These accumulated monies become the pool of funds which will be used both to acquire or otherwise control a pool of homes and to lend to a prospective purchaser to finance the purchasing of a home.

Second, the transaction enabling the purchase of the home includes a home financing instrument that includes provisions similar to those found in a non-recourse finance agreement. The non-recourse finance agreement is executed by the home buyer. The effect of using a non-recourse finance agreement as the financing instrument enables reversion of the title to the property to the business organized and operating similar to the organization an operation of a traditional REIT should the purchaser not make the scheduled payments to repay the loan used for purchase of the residence.

Third, if the home purchaser finds himself in a situation where it is necessary to move away from the purchased home, the home purchaser may either sell the home or surrender the purchaser's interest in the home back to the business organized and operating like a traditional REIT pursuant to a non-recourse forfeiture agreement between the seller and the buyer.

Accordingly, the non-recourse forfeiture agreement provides the home buyer with the advantage of having a guaranteed sale of the purchased home back to the business organized and operating like a traditional REIT.

More particularly, the disclosed invention features an efficient method of providing permanent financing for single family homes wherein much of the traditional investor risks and transactional costs have been eliminated or substantially reduced.

A typical transaction, according to the method of the disclosed invention, includes the following features:

1. the customer selects a home from an available pool of homes owned or controlled by a company organized and operating like a REIT;

2. the company provides permanent financing to the home purchaser;

3. optionally, the company may collect a monthly fee in addition to the mortgage payment in exchange for financial assistance for unexpected major repairs by the home buyer;

4. the home buyer has the right to sell the purchased home at any time to anyone without penalty;

5. throughout the financing period, the company remains obligated to buy the house back from the home buyer for an amount equal to the sum of the remaining balance less applicable costs and/or cure for repairs outside the scope of normal wear and tear;

6. the home buyer is allowed to transfer their mortgage equity and the amount of their original down payment to another home within the company's pool of homes, if desired, less a small transaction fee;

7. the company reserves the right to make an offer above that of item (5) or item (6) if company feels there has been a substantial increase in the market value of the home due to market appreciation or due to improvements made by the home buyer;

8. the company will periodically report the home buyer's payment history to the major credit bureaus; and

9. in the case of an uncured forfeiture, the company will give the home buyer an opportunity to cure the payment shortage. If the home buyer is unable to cure the payment shortage, the company will provide financial assistance to cover relocation costs in exchange for a voluntary surrender of the property.

10. If the home buyer cures the payment shortfall and reimburses the company for relocation expenses incurred by the company for the benefit of the customer, the transaction will be reported to the various credit reporting bureaus as having been “paid according to terms.”

### BRIEF DESCRIPTION OF THE FIGURES

A still better understanding of the disclosed real estate financing system and method may be had by reference to the drawing figures wherein:

FIG. 1 is an organizational diagram illustrating the relationship of a business using the disclosed system and method to the other parties involved in the purchasing of a home and the financing of the purchase price of a home in the preferred embodiment;

FIG. 2 is a flow chart illustrating the beginning of the disclosed method wherein a prospective buyer is introduced to and qualifies for participation in the disclosed method;

FIG. 3 is a flow chart illustrating the completion of the purchase of a selected home using the preferred embodiment of the disclosed method; and

FIG. 4 is a flow chart illustrating the options available to the home owner if the home owner elects to sell the home purchased according to the disclosed method.

### DESCRIPTION OF THE EMBODIMENTS

In the following description of the disclosed system and method the following terms have been used. Such terms are best interpreted according to the definitions listed below.

“RTO model” refers to the set of steps according to the system and method of the disclosed invention.

“Company” refers to a business using the RTO model. The company may be a corporation, an LLC, a partnership, a sole proprietorship, or any business organization which has the ability to make use of the disclosed RTO model. The company may be owned by a group of investors. The company may own a pool of homes. The company may also manage a pool of homes owned by potential home sellers to include individual, individuals, or groups of individuals. Alternatively, the company may manage a pool of homes owned by another company, organization, or owned together with another company as a joint venture. In addition, the company may develop and maintain a list of pre-qualified buyers. In certain circumstances the company may provide home maintenance services, act as rental agent for a home owner, or provide financing for the material and labor associated with unexpected repairs.

“Investor” refers to an individual, group of individuals, trusts, institutions, another company or another business enterprise who invest money and/or other forms of capital in the company. Dividends may be paid to investors based on the combination of the contracted sale price of homes being financed and the running average of interest rates charged to finance homes within the pool of homes owned by the company. Such dividends will become available following a closing on the purchase of a home.

“Pool of homes” refers to a group of homes owned or similarly controlled by the company and defined in terms of geographic area, total value of the group of homes or the average value of the individual homes within the group of homes, or other parameters useful in distinguishing one group of homes from another group of homes. The individual homes in the pool of homes may come from a variety of different sources to include: (a) homes being liquidated by a builder or investor; (b) homes foreclosed on by a bank; (c) short sale homes; (d) homes consigned for sale; (e) homes acquired from users of the RTO model; (f) custom built homes; and (g) any other homes which may be suitable for use with the disclosed RTO model. One pool of homes may overlap with another pool of homes.

“Real Estate Investment Trust” (REIT) refers to the general type of investment vehicle structure used by the company to facilitate investment in the company by the investors whereby the investors are able to buy and sell shares in the company and receive a return on the shares based on either the profitability of the company or the financial performance of a pool of mortgages. The pool of mortgages associated with a traditional REIT may be associated with specific properties within a geographic region, certain properties within larger group of properties, or a diversified composite of shares in two or more pools of properties in different regions.

“Home” or “Residence” refers to a property intended for use by a single family, an individual or a group of individuals. Such property may be a detached house, a multi-family house, a condominium or an apartment.

“Prospect” refers to an individual or a group of individuals who are considering either financing or re-financing the amount of money needed to purchase or re-finance a home.

“Applicant” refers to a prospect or a prospective home buyer who has decided to apply for a loan from the company using the steps of the disclosed RTO model to purchase a home. The home may come from an open market list of homes approved by the company for financing, or from the open market where the company repairs or refurbishes a home or from a pool of homes owned or otherwise controlled by the company.

“Customer” refers to an applicant who finances the purchase of a home using the steps of the disclosed RTO model.

“Homeowner” refers to a customer who has financed and closed on a contract to acquire possession of a home using the steps of the disclosed RTO model.

“Home buyer”, as used herein to describe the disclosed invention, is a generic term including a prospect, an applicant, a customer or a homeowner.

“Non-recourse Finance Agreement” refers to a financing instrument which, where permitted by state law, permits the company to retain title to a home until the loan used to the finance the purchase of a home is fully paid while the homeowner occupies the home, cares for the home, is able to use the home for a personal tax deduction, is able to build equity in the home, is able to the rent the home to another if needed, and retains the right to sell the home at any time without restriction or penalty.

“Non-Recourse Forfeiture Agreement” refers to that part of the disclosed RTO model that provides the customer with the assurance that the customer may terminate financial obligations to the company after becoming a homeowner by providing the company with an executed request under the non-recourse forfeiture agreement prior to selling the home or surrendering the home back to the company.

For example, the non-recourse forfeiture agreement may be used as a convenient alternative to selling a home privately on the open market as an individual or through a real estate agent when the homeowner is facing a divorce, the loss of a job, relocation, or simply the desire to buy another home. The non-recourse forfeiture agreement may contain a variety of terms benefitting both the homeowner and the company. For example, the non-recourse forfeiture agreement may contain:

A requirement for the existence of a maintenance and repair agreement on major household systems;

Provisions for the transfer of title through the use of a warranty deed to the home owner when the home loan has been fully paid off;

Restrictions on the use or rental of the home;

A standard of care requirement for the home;

Approval of improvements or modifications to the home by the company;

A right of first refusal for repurchase of the home by the company;

A minimum level of major risk insurance to be paid for and maintained by the home owners;

Procedures governing the voluntary or involuntary surrender of the home to company.

A still better understanding of the disclosed RTO model may be had by an understanding of the relationships of the people and the homes which are the essential parts of the disclosed system and method of the present invention.

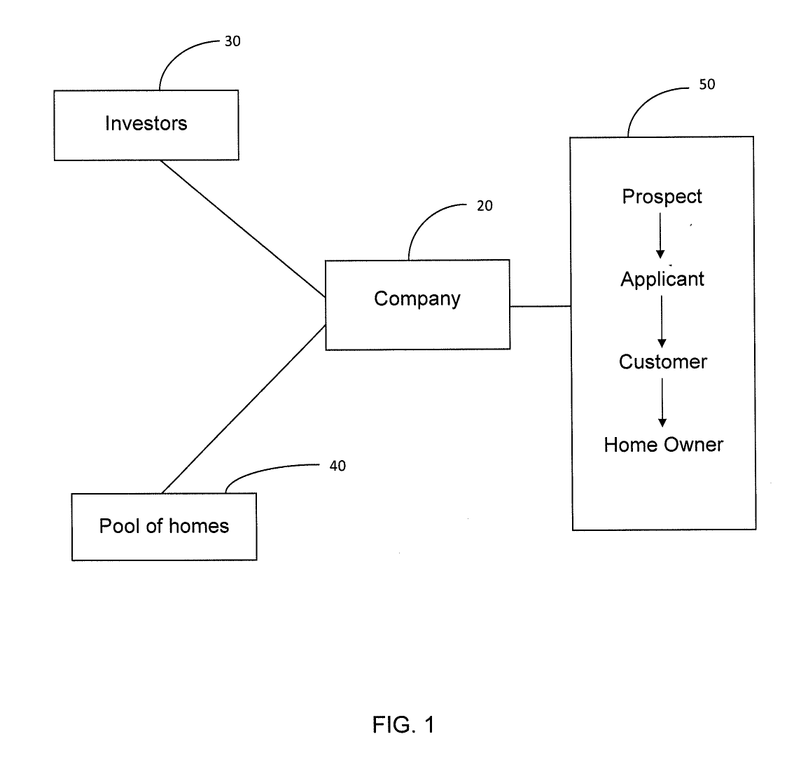

Shown in FIG. 1, at the center of the diagram, is the company 20. The company is owned by a group of investors 30 who provide the necessary funds for the company 20 to effect the disclosed RTO model. The company 20 is organized and operates like a traditional REIT. The way in which the company 20 makes money is by use of the disclosed RTO model of the present invention. In the preferred embodiment the company 20 will acquire title to individual homes within a pool of homes 40. It is the company 20 that makes and retains contact with the home buyer 50.

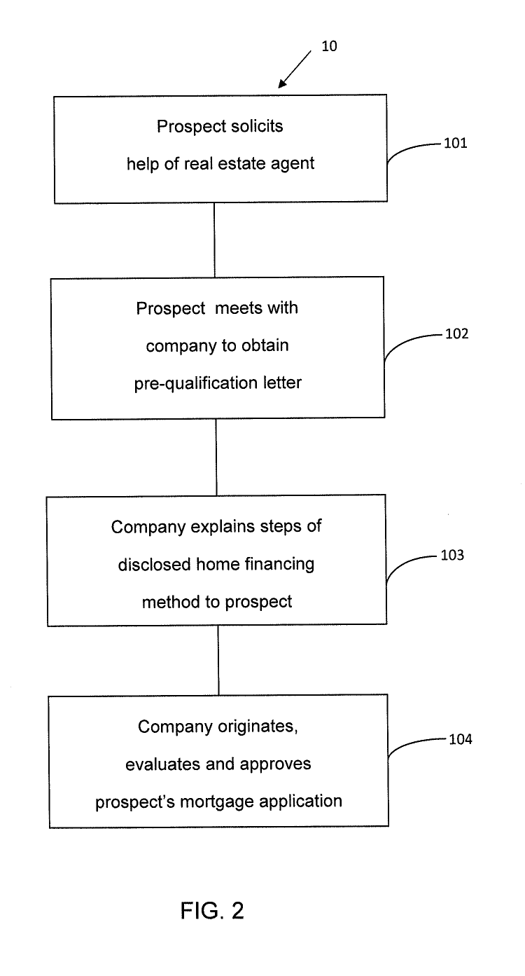

As may be seen by reference to FIG. 2, the completion of the steps of the disclosed RTO model 10 begins when a prospect learns about the RTO model, is interested in a house owned or otherwise controlled by the company, or solicits the assistance of a real estate agent 101 who is employed by the company using the RTO model. It is at this point 102 that the relationship between the prospect and the company begins. The company will explain the RTO model to the prospect 103 and do an initial evaluation of the prospect's loan qualifications based upon the unverified information provided by the prospect 104. Such initial check will include both the traditional indicators of credit worthiness such as a credit report along with a closer look at the most recent two-year financial history of the prospect. For example, the initial check will look at the prospect's employment history, income and credit, and any recent financial disruptions.

If the initial assessment of the prospect's financial history appears to be satisfactory, the company will issue a pre-qualification letter to the prospect. If there is a problem with the initial evaluation of the prospect's qualifications with regard to income, employment history or credit history, the prospect will be provided with an action plan to guide the prospect toward meeting the requirements necessary to qualify for home financing at some point in the future using the disclosed RTO model.

Once the prospect has been pre-qualified, the company may provide the prospect with either a virtual or a physical tour of homes available for sale. In the preferred embodiment, the homes shown to the prospect are in the pool of homes owned or otherwise controlled by the company.

Along with the pre-qualification letter the company will provide the prospect with a more detailed explanation of the disclosed RTO model to include the non-recourse forfeiture agreement. If the prospect indicates a willingness to participate in the disclosed RTO model, the company will originate, review and, if satisfactory, approve the application of the prospect to obtain a loan for the money necessary to finance the purchase of the selected home. At this point in the execution of the steps of the RTO model the prospect will now be called an applicant for the purposes of providing clarity to the description of the disclosed RTO model.

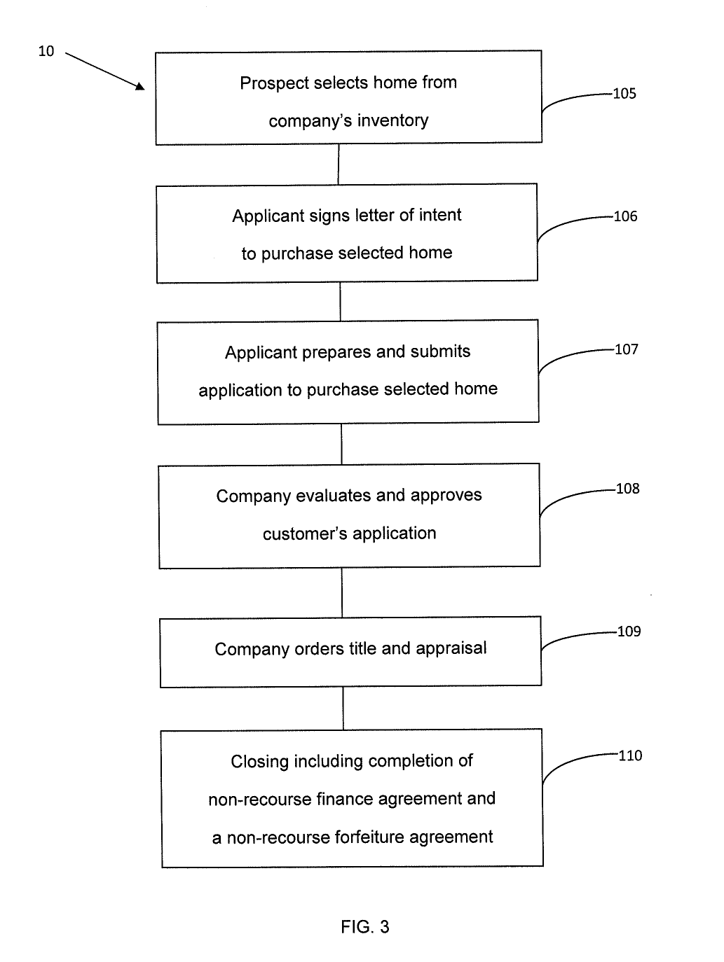

As shown in FIG. 3, which continues the description of the preferred embodiment of the RTO model, the Applicant has selected a home from the pool of homes owned or otherwise controlled by the company 105. The selection of the home is confirmed with the completion of a letter of intent to buy the selected home signed by the applicant and provided by the applicant to the company 106. The next step is the preparation of an application by the applicant to obtain the necessary monies to finance the purchase of the selected home 107. Once submitted, the application to purchase the selected home is submitted to the company. At this point in the description of the RTO model, the applicant will now be referred to as a customer for the purposes of clarity.

The company evaluates the customer's application to obtain the monies needed to purchase the selected home 108. If the customer's application is accepted and meets the standards of the home loan underwriters used by the company, the company requests an appraisal of the selected property and obtains the necessary paperwork to both assure a proper chain of title to the homeowner and to effect a re-assignable transfer of the title to the home, if a transfer of title is required by local law 109.

Typically, the disclosed system encompasses the necessary paperwork to include: the application to obtain financing for the purchase of the home, the non-recourse finance agreement which serves as the financing instrument and gives the homeowner the right to resell the home without restriction or penalty, evidence of an unencumbered title, an optional home maintenance insurance contract defining the company's obligation to assist the homeowner with predetermined maintenance expenses, the non-recourse forfeiture agreement, the creation of escrow accounts for payment of taxes and catastrophic loss insurance, and any applicable disclosures or forms required by local law or regulation.

To assure a commitment by the customer to complete the acquisition of the home, a small non-refundable down payment will typically be required from the customer. This down payment will be applied to the contract price of the home and; at any time in the future, may be transferred to another home within the original pool of homes or to another pool of homes owned or otherwise controlled by the company.

When all of the paperwork to complete the home purchase transaction is completed a closing is scheduled. At the closing, the customer signs the non-recourse finance agreement and the non-recourse forfeiture agreement 110.

The paperwork will include an acknowledgement by the customer of the non-recourse forfeiture agreement which is an essential part of the disclosed RTO model. Once the closing has been completed the Customer is now termed a homeowner for the purpose of clarity.

In states where a non-recourse finance agreement is not permitted by local law or regulation; that is, where the title to the home must pass to the home buyer, the customer will enter into an agreement having the same effect as a non-recourse finance agreement which will allow the company to re-acquire title to the home upon the occurrence of certain predetermined conditions.

Once the closing is complete the homeowner will occupy the home and be responsible for all of the home maintenance costs. To minimize the impact of unforeseen maintenance expenses on the customer, the company may require the purchase of a home warranty policy as part of the closing or provide similar protection for an additional fee. The home warranty policy will be maintained until a predetermined level of equity in the home has been obtained by the homeowner or for a predetermined period of time.

If no extraordinary events occur, the homeowner will make all of the necessary payments to the company scheduled to pay off the note 111. When the satisfactory completion of all payments have been made, a warranty deed for the home passes from the company to the homeowner.

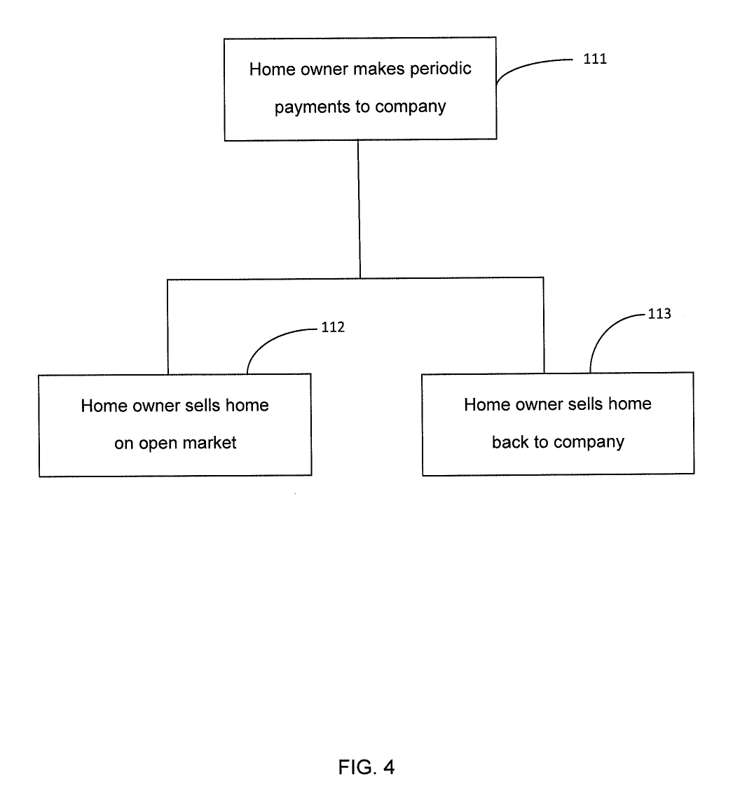

As shown in FIG. 4, it is not unusual for unanticipated events to occur after there is a closing on the purchase of a home which alter the customer's specific needs, their preferences and/or their income or ability to pay the money needed to purchase their home.

The homeowner, for a variety of different reasons, may decide to sell the home individually or through a real estate agent on the open market 112. The sale of a home is not unusual as many homeowners are likely to upgrade their residence when a growth in income occurs or the size of a family increases.

If the effort by the homeowner to sell the home on the open market is not successful or the homeowner believes that the net equity in the home is less than the projected costs associated with selling the home on the open market, or if the homeowner desires to sell the home or otherwise terminate ownership of the home as soon as possible, the homeowner may decide to exercise the guaranteed resale provision in the non-recourse forfeiture agreement and transfer the home to the company 113. In such cases, the homeowner may avoid the necessity of paying a real estate agent or incurring transaction costs and fees such as those paid to a title company or a real estate attorney.

If the homeowner is no longer able to make the mortgage payments for some unforeseen reason, the company may utilize the non-recourse forfeiture agreement to regain possession of the home from the homeowner. For example, if the homeowner misses a predetermined number of payments, the home owner has the option of being moved by the company to a new location of the homeowner's choice within a predetermined distance of their home and/or having their personal property placed in a storage facility by the company for a predetermined period of time. Exercise of the relocation or storage of personal property will be conditioned on the physical condition of the home, a voluntary surrender of the home, and the promise by the homeowner to abide by the remaining terms of the non-recourse finance agreement. If the missed payments and/or cost of relocation and/or cost providing for the storage of the homeowner's personal property incurred by the company on behalf of the homeowner are paid by the homeowner or otherwise reimbursed to the company, the homeowner will be able to avoid a report of foreclosure on the home and the consequences of a bad credit report, providing that the homeowner reimburses the company within the agreed upon period of time, such as within twelve (12) months from the date of forfeiture.

The non-recourse forfeiture agreement provides a convenient no-risk option for the homeowner without the need to sell the home on the open market. Further, use of the non-recourse forfeiture agreement provides a cost-effective solution to those homeowners who may have built up sufficient equity in their homes to offset sales commissions and closing costs while the amount expected at settlement is insignificant in comparison to the benefit of the expediency provided by the non-recoverable forfeiture. Once a home is transferred under the non-recourse forfeiture agreement, the homeowner will be free of any further obligations with regard to the home and the transaction will be reported to the credit rating bureaus as being paid according to the terms in the loan agreement.

In the situation where a homeowner is current on home loan payments but desires to purchase another home within the pool of homes, the equity in the home resulting from the home loan payments and the amount of the down payment may be transferred by the company to the newly purchased home from the pool of homes.

Companies who implement the disclosed RTO model will be attractive to investors. The reason is that companies implementing the disclosed RTO model will be able to prosper whether the overall economy is headed up or down. Specifically, in a recessionary economy additional homes will become available for purchase by the company using the RTO method at favorable prices. Likewise, during recessionary periods, the demand for alternative financing options to purchase homes, such as that provided by the disclosed RTO model, becomes more attractive to prospective homebuyers. In periods of economic growth, the investors in the company will be able to expect an above average appreciation of their investment as the value of the homes in the pool of homes grows.

Further, use of the RTO model will enable the company to recapture some of the equity which traditional lenders and homeowners have lost in recent years. The company employing the disclosed RTO model will experience a better cash flow and return on investment than those companies providing traditional mortgage backed securities (RMBS). Routine home maintenance and the payment of property taxes will be the responsibility of the homeowner. Equity forfeited when the non-recourse forfeiture agreement is utilized will be recaptured by the company. The traditional costs associated with home foreclosures by the holder of a mortgage are effectively eliminated when the non-recourse forfeiture agreement is utilized.

Use of the RTO model provides new opportunities for prospective home buyers. Specifically, prospective home buyers will not find themselves permanently stuck in a home which no longer meets changing needs. Thus, an ease of transitioning to another home more satisfactory to the homeowner's needs is provided. Such homeowner needs include larger families or smaller families. Homeowners also need not be concerned about timing swings in the real estate market to decide when to make a change in their residence.

Use of the RTO model also benefits homeowners. Specifically, the process of buying a home is simplified as is the process of selling a home. The non-recourse forfeiture agreement provides the homeowner with a financial safety net in the case of an unexpected negative financial event such as medical expenses or the loss of employment. At the same time the homeowner has more flexibility to pursue employment opportunities in other areas of the country. While the homeowner is making regular payments, the homeowner is building up an equity interest in the property as well as being able to take the personal tax deductions available to homeowners. When a homeowner leaves a home, all transactions are handled at one location by the company. Additionally, once the homeowner has acquired a predetermined level of equity in a home, under the RTO model, the company may make a cash-out offer to the homeowner. Such cash-out offer may be attractive to those homeowners considering a move to another location or possibly considering selling their home.

Those of ordinary skill in the art will understand that the invention has been described according to its preferred embodiment where the purchased home is selected from the pool of homes owned or otherwise controlled by the company. In alternate embodiments, the RTO model may be applied to other types of real estate related transactions. For example, an existing homeowner may desire to refinance a home according to the RTO model or may have a refinancing need to obtain additional funds to refurbish or repair an existing home, or where the company provides repairs or refurbishes and existing house. In yet another embodiment, a home buyer may select a home outside the pool of homes owned by the company but choose to use the RTO model to arrange payment for the selected home. In still another embodiment, the home buyer may elect to have a home designed and built. Upon completion of the home, the home buyer may use the RTO model to pay for the home. Alternatively, the company may arrange for the building of homes to be sold using the RTO model. In addition, in situations where a multi-unit dwelling is converted from rental spaces to a condominium, use of the RTO model will allow those formerly renting an apartment to buy their living space as a condominium from the owner. Alternatively, the RTO model may be used for the purchase of multi-family dwellings.

The purpose of the disclosed RTO model is to simplify and to reduce the risk of buying a home for both the home buyer and the lender who is assisting the home buyer in obtaining the home. Such reduction in risk applies to the credit worthiness of the home buyer and the capital risk for the lender providing the funds needed to make the home purchase. Further, the disclosed RTO model facilitates and simplifies the relinquishment of a home if circumstances so dictate. Accordingly, the underwriters working with the company to approve requests for home financing are more likely to approve the purchase of a home using the RTO model.

All involved with the use of the disclosed RTO model will benefit from the increased efficiencies in the transfer of homes and the reduction of risk. The reduction in the current inefficiencies in the transfer of homes will both reduce operational costs and minimize the downside risks for those providing the money to finance loans used to purchase a home.

Those who may be reluctant to purchase a home or who have had recent unanticipated financial setbacks are now transformed into one being able to become a home buyer. Once a home is purchased using the disclosed RTO model, the home buyer may be able to accrue equity in the home faster than with a traditional mortgage. Accelerated accruance of equity in a home will enable faster exit from a home in the event of unforeseen circumstances.

While the preferred and alternate embodiments of the present invention have been disclosed, those of ordinary skill in the art will understand that still other variations, changes, and embodiments with respect to real estate transactions will become obvious once having read and understood the foregoing disclosure. Such other variations, changes and embodiments shall be included within the scope and content of the appended claims.

What is claimed is:

1. A method for transforming a situation where a potential homeowner is unable to borrow the money needed to buy the residence and a potential home seller is unable to sell a residence into a situation where a potential homeowner is able to borrow the money needed to buy a residence and a potential home seller is able to sell a residence, said method comprising the steps of:
using the monies accumulated from investors in a business to provide the money needed by the prospective home buyer to buy the residence;
requiring that the prospective home buyer enter into a non-recourse finance agreement as part of the process of acquiring the right to occupy the residence; and
enabling the home buyer to either:
sell the residence outright; or
to execute a non-recourse forfeiture agreement for sale of the residence back to the business lending the homeowner the money needed to buy the residence.

2. The method as defined in claim 1 wherein said business operates as a real estate investment trust.

3. The method as defined in claim 1 wherein said business owns or otherwise controls a pool of homes from which the home buyer is able to select a home.

4. The method as defined in claim 1 wherein said business manages a pool of homes owned by an individual, multiple individuals or a groups of individuals.

5. The method as defined in claim 1 wherein said business manages a pool of homes owned by another company or organization.

6. The method as defined in claim 1 wherein said business manages a pool of homes owned by another company or organization in a joint venture.

7. The method as defined in claim 1 wherein said home buyer is able to choose a home from the open market.

8. The method as defined in claim 1 wherein said home buyer is able to choose a home from the open market from a list of homes approved by said business for financing.

9. The method as defined in claim 1 wherein said home buyer is able to choose a home from the open market whereby said business repairs or refurbishes the home for the home buyer.

10. The method as defined in claim 1 wherein said home buyer is refinancing the mortgage on an existing home.

11. The method as defined in claim 1 wherein the home buyer is refinancing the money owed on the loan to buy an existing home whereby additional funds are provided to refurbish the existing home.

12. The method as defined in claim 1 wherein said home buyer is refinancing the amount owed on the loan to buy an existing home and said business provides repair or refurbishing services on said existing home.

13. The method as defined in claim 1 wherein said home buyer is purchasing a condominium.

14. The method as defined in claim 1 wherein said home buyer is purchasing a multi-family home.

15. The method as defined in claim 1 wherein said home buyer is purchasing a home being constructed according to the plans and designs of said home buyer.

16. The method as defined in claim 1 wherein said home buyer is purchasing a home being constructed according to the plans and designs of the business.

17. The method as defined in claim 1 wherein responsibility for the care and maintenance of the home is transferred to said home buyer.

18. The method as defined in claim 1 wherein said home buyer is required by the business to purchase a home warranty policy.

19. The method as defined in claim 1 wherein said business provides financial assistance to said home buyer for completion of major unexpected repairs.

20. The method as defined in claim 1 wherein said business provides said home buyer with material and labor for the completion of unexpected repairs.

21. A method for facilitating both the acquisition and relinquishment of a home by a home buyer, said method comprising the steps of:
pre-qualifying the credit worthiness of a prospective home buyer;
enabling the prospective home buyer to select a home for purchase from one of a group of sources including:
a. a pool of homes;
b. a home available on the open market; and
c. a designed but un-built home;
qualifying the prospective buyer for a mortgage loan on the selected home;
requiring that the prospective home buyer sign a non-recourse finance agreement at the time of the acquisition of the home;
funding the purchase of the home by the home buyer; and
providing the home buyer with a non-recourse forfeiture agreement enabling the homebuyer to sell the home or requiring that the party funding the purchase of the home by said home buyer purchase the home at a predetermined purchase price.

22. The method as defined in claim 21 wherein said pool of homes is owned, managed or otherwise controlled by said party funding the purchase of the home.

23. The method as defined in claim 21 wherein utilization of said non-recourse forfeiture agreement is effected at the request of the home buyer.

24. The method as defined in claim 21 wherein utilization of said non-recourse forfeiture agreement is effected at the request of the party funding the purchase of the home.

25. The method as defined in claim 21 wherein the prospective home buyer is required to pay a non-refundable down payment at the time of purchase of the home.

26. The method as defined in claim 25 wherein said non-refundable down payment is used to fund repairs on the home after utilization of said non-recourse forfeiture agreement has been effected.

27. The method as defined in claim 21 wherein the utilization of said non-recourse forfeiture agreement by the party funding the purchase of the home is conditioned on a set of predetermined circumstances involving the re-payment of the monies by the homeowner to the party funding the purchase of the home.

28. The method as defined in claim 21 wherein utilization of said non-recourse forfeiture by the homeowner is preceded by a notice to the party funding the purchase of the home.

29. The method as defined in claim 21 wherein the home buyer is required to buy a home maintenance insurance policy.

30. A home financing system for transforming a condition where a potential home buyer is unable to finance the purchase of a home and a potential home seller is unable to effect the sale of a home, said home financing system comprising:
a non-recourse finance agreement between the entity providing the financing to the home buyer and the homebuyer;
an obligation by the entity providing the financing to the home buyer to re-acquire the right to occupy the home from the home buyer upon the occurrence of:
failure of the home buyer to make scheduled payments to the entity providing the financing to the homebuyer; or
a request by the home buyer to the entity providing the financing to the home buyer to relinquish the right to occupy the home; and
an obligation by the home buyer to pay for a home maintenance insurance policy.
